(19) United States
(12) Patent Application Publication
(10) Pub. No.: US 2026/0338263 A1
(43) Pub. Date: Oct. 29, 2026

(54) INTEGRATED GEAR RING PLANETARY ROLLER NUT AND PLANETARY ROLLER SCREW ASSEMBLY

(71) Applicant: Tolomatic, Inc., Hamel, MN (US)

(72) Inventors: Brett Christopher Holker, Monticello, MN (US); Jeremy Reid Forbord, Mound, MN (US); Joshua David Christian, Saint Michael, MN (US); Roland Paul Walti, Rogers, MN (US); Lucas Paul Keranen, Orono, MN (US); Sean Henry Halverson, Maple Grove, MN (US); Eric Martins Schaupp, Minneapolis, MN (US)

(21) Appl. No.: 19/652,677

(22) Filed: Apr. 20, 2026

Related U.S. Application Data
(60) Provisional application No. 63/794,702, filed on Apr. 25, 2025.

(51) Int. Cl. F16H 25/22; B25J 9/12; B62D 57/032; F16H 25/20

(52) U.S. Cl. CPC F16H 25/2252; B25J 9/123; B62D 57/032; F16H 2025/2031; F16H 2025/2075; F16H 2025/2271

(57) ABSTRACT

A roller nut assembly has a carrier with an inner carrier thread defined on an inner surface and a set of gear ring teeth defined on each opposing end. A plurality of rollers can be disposed inside the carrier, circumferentially arranged about the axis, with external roller threads engaging the carrier thread and sets of roller gear teeth defined at opposing ends, engaging the gear ring teeth. The gear ring teeth can be defined directly on the inner surface of the carrier, and formed of the same continuous material with the carrier and carrier thread, without the need for screws, pins, welds, or other mechanical coupling. The gear ring teeth each extend from a root to a crest, with the roots defining a gear root diameter at least as great as the carrier thread diameter, and the crests defining a gear tooth diameter no greater than the carrier thread diameter.

### CROSS-REFERENCE TO RELATED APPLICATIONS

This application claims priority to U.S. Provisional Patent Application No. 63/794,702, “Integrated Gear Ring Planetary Roller Nut and Planetary Roller Screw Assembly,” filed Apr. 25, 2025, which is incorporated by reference herein, in the entirety and for all purposes.

### FIELD

This application relates to linear actuator systems and planetary roller screw components, and more generally to planetary roller screw and roller nut assemblies for use in linear actuators and other screw-driven mechanical devices. Suitable applications include, but are not limited to, planetary roller screw assemblies and roller nut components adapted for use in integrated motor linear actuators, and other mechanical systems.

### BACKGROUND

Screw-driven actuators and similar mechanical devices are used in a wide range of automation systems, including linear and rotary actuators adapted to control the movement and operation of automated machine tools and robotic systems. Suitable applications include clamping fixtures, welding guns, soldering equipment, cutting and machining tools, sprayers, casting and molding fixtures, and automated mechanical devices for manufacturing, packaging, assembly, transportation, electronics, food processing and coating industries.

While hydraulic and pneumatic actuator systems have traditionally been used across many of these different industries, electric motor-driven actuators have been increasingly adopted. These include both external motor actuators and integrated motor electric actuators, which can be designed to meet increased loading demands while eliminating the risk of pneumatic or hydraulic fluid leaks, as well as the need for compressed air or pressurized fluid systems. Electric motor actuators can also provide increased positioning accuracy, while maintaining or improving upon design requirements for speed, torque, power and fixture loading.

Roller screw linear actuators provide high-force, heavy-duty loading capabilities in a compact, reliable design envelope. The roller screw can utilize precision-ground screw threads that match multiple precision-ground rollers in the planetary roller nut, providing substantially greater, more reliable and wear-resistant contact surfaces than other designs. Improved planetary roller screw and roller nut assemblies can also provide higher force capability, with increased surface hardness and high dynamic load rating for greater service life.

Across these different applications, there remains a need for electric motor linear actuators and screw-driven mechanical devices with improved operational reliability, loading, and precision positioning capabilities. There is also a need for increased design efficiencies, including improvements to planetary roller screw assemblies and roller nut devices that are not subject to the same limitations of the prior art.

### BRIEF DESCRIPTION OF THE DRAWINGS

FIG. 1 is a front isometric view of a linear actuator system, arranged along longitudinal axis A.

FIG. 2A is a rear isometric view of the actuator system.

FIG. 2B is a rear elevation view of the actuator system.

FIG. 3 is a section view of the actuator system, taken along line B-B in FIG. 2B.

FIG. 4A is an end view of an output rod and roller nut assembly for an actuator system.

FIG. 4B is a section view of the output rod and roller nut, taken along line C-C of FIG. 4A.

FIG. 5 is an exploded view of a planetary roller nut, with integrated gear ring design.

FIG. 6A is an end view of an assembled roller nut.

FIG. 6B is a section view of the roller nut, taken along line D-D of FIG. 6A

FIG. 7A is an end view of a planetary roller screw assembly for an actuator system, with integrated gear ring design.

FIG. 7B is a section view of the roller screw assembly, taken along line E-E of FIG. 7A.

FIG. 8A is an end view of a planetary roller nut carrier, with integrated gear ring.

FIG. 8B is a section view of the carrier, taken along line F-F of FIG. 8A.

FIG. 9A is an end view of the carrier, illustrating the integrated gear ring.

FIG. 9B is a detail view of the carrier, illustrating the gear ring teeth.

### DETAILED DESCRIPTION

Planetary roller screw assemblies typically include a screw shaft with an outer thread and a coaxial nut carrier with an inner thread. A set of planetary rollers are arranged circumferentially about the inside of the carrier, extending longitudinally along the central axis and positioned radially between the carrier and screw shaft. The middle section of each roller has external threads configured for simultaneously engaging the outer thread of the screw shaft and the inner thread of the carrier. The rollers can also have externally geared sections at each end, configured to engage with synchronizing gear rings disposed at corresponding ends of the carrier. The gear rings engage the roller gear teeth to coordinate synchronized rotation of the planetary rollers within the carrier.

In traditional designs, the synchronizing gear rings are formed as distinct, separate components, which must be drilled and pinned for connection to the carrier, or otherwise mechanically fastened to the nut. The integrated gear ring planetary roller nut design described here, in contrast, removes the need for the synchronizing gear ring teeth to be pinned, glued, or fastened to the nut or carrier in this manner. Instead, the gear ring teeth can be machined into or formed directly onto the inner circumference of the carrier, providing for reduced size, weight and manufacturing complexity.

The integrated gear ring design can also utilize a novel gear root diameter to thread minor diameter ratio, providing additional advantages over the prior art. As described below, the synchronizing gear ring teeth have a root diameter that is larger than the inside diameter of the inner carrier thread. Thus, the root or trough of each gear tooth is disposed radially outward of the inner carrier thread, with the cusp or crest disposed radially inward of the carrier thread.

Traditional techniques for forming carrier threads and gear ring teeth could be problematic for gear ring teeth manufactured according to this integrated gear ring design, because (for example) the tool used to form the gear ring teeth could also cut into the carrier thread., or the tool used to form the carrier thread could cut into the gear ring teeth. To address these and other problems, different manufacturing techniques can be used for forming the inner carrier thread and gear teeth, as adapted to provide the desired gear ring tooth and inner carrier thread diameters described here.

One advantage of this technique is reduced manufacturing time and cost for producing integrated gear ring planetary roller screw and roller nut assemblies. In the designs described here, the synchronizing gear ring teeth can be machined, cut or formed directly into or onto the inter circumference of the carrier body. Integrating the gear rings into the carrier material also reduces or eliminates the need to source or manufacture separate gear ring components, which would then need to be coupled to the carrier as distinct elements of the planetary roller nut and roller screw assembly.

The gear ring teeth can also be formed during the same machine setup and process used to machine other features into or onto the carrier, reducing the number of manufacturing steps by eliminating the need to drill and pin the gear rings, or otherwise attach them to the carrier. Integrated gear ring designs also offer performance benefits such as higher strength, more durable gear ring components, increased mass to enhance thermal performance, and improved gear-to-gear alignment to increase operational efficiency of the planetary roller screw assembly.

### Integrated Motor Linear Actuator Systems

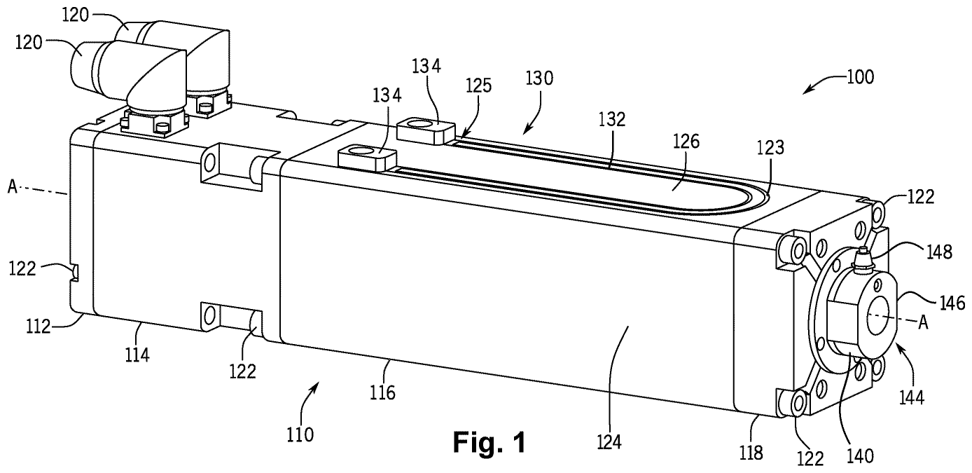

FIG. 1 is a perspective view of an actuator system 100, for example an integrated motor linear actuator 100 disposed within a housing 110, as described herein. As shown in FIG. 1, housing 110 includes a rear cover 112 coupled to a rear housing 114, a main housing section (or central housing) 116 coupled between the rear housing 114, and a front cover or head assembly 118 coupled to the central housing 116.

One or more external connectors 120 can be configured to provide power and control connections for actuator 100, and a cooling system 130 can be provided in or on housing 110. A thrust tube or output rod 140 extends from housing 110 at head assembly 118. An electric motor and planetary roller screw assembly can be disposed within actuator housing 110 to drive output rod 140 in reciprocating motion along longitudinal axis A, using an integrated gear ring roller screw assembly and roller nut configuration as described herein.

In the particular example of FIG. 1, rear housing 114 is coupled to central housing 116 and head assembly 118 with threaded rods, screws, nuts, bolts or other mechanical couplings 122. Additional screws, bolts or mechanical couplings 122 can be provided to connect the rear cover 112 to the rear housing 114. The particular size, shape and configurations of the rear cover 112, rear housing 114, central housing 116, and head assembly 118 may also vary, along with the corresponding mechanical couplings 122.

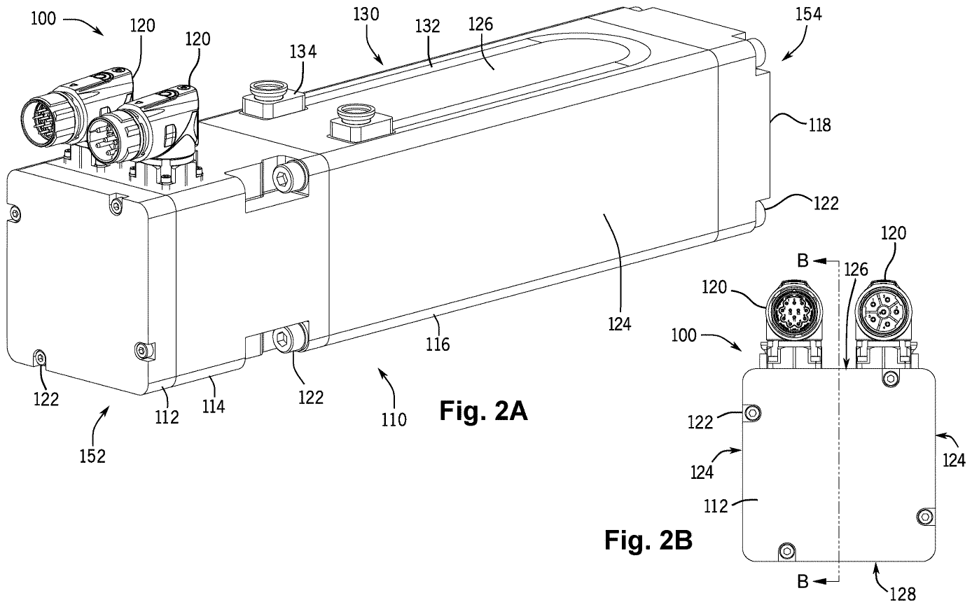

For example, housing 110 can be provided in a generally square or rectangular configuration as shown, with lateral sides 124 extending between the generally horizontal top and bottom sides 126, 128 (see also FIG. 2B). Housing 110 can also be provided in a cylindrical or polygonal form, or other configuration. Any one or more of the rear cover 112, rear housing 114, central housing 116 and head assembly 118 can also be provided as integral components of the housing 110, or as multiple, individual and distinct housing components.

Similarly, external connectors 120 can be disposed on the rear housing 114 as shown, or on central housing 116, rear cover 112 or on the head assembly 118. Connectors 120 can be adapted for a range of different external systems and processes, for example to provide electrical connections between actuator 100 and a power source, of to provide data connections to an external computing device configured to control operation of actuator 100, or both. Suitable external connectors 120 can also be adapted for wired or wireless power, data and control connections, and according to various standardized or customized automation system communication protocols.

A cooling system 130 can be provided in or on housing 110, for example with a cooling loop 132 disposed on or in the top 126 of the central housing 116. Fluid couplings 134 can be provided for connecting the loop 132 to a cooling fluid supply; e.g., according to U.S. Pat. No. 11,754,157 B2, which is incorporated by reference herein, in the entirety and for all purposes. Suitable cooling systems 130 can also be provided on one or more sides 124 or the top 126 or bottom 128 of housing 110, or coupled to housing 110 in modular form and configured with either active or passive (e.g., radiative or convective) components as described in U.S. Pat. No. 10,626,980 B2, which is incorporated by reference herein, in the entirety and for all purposes.

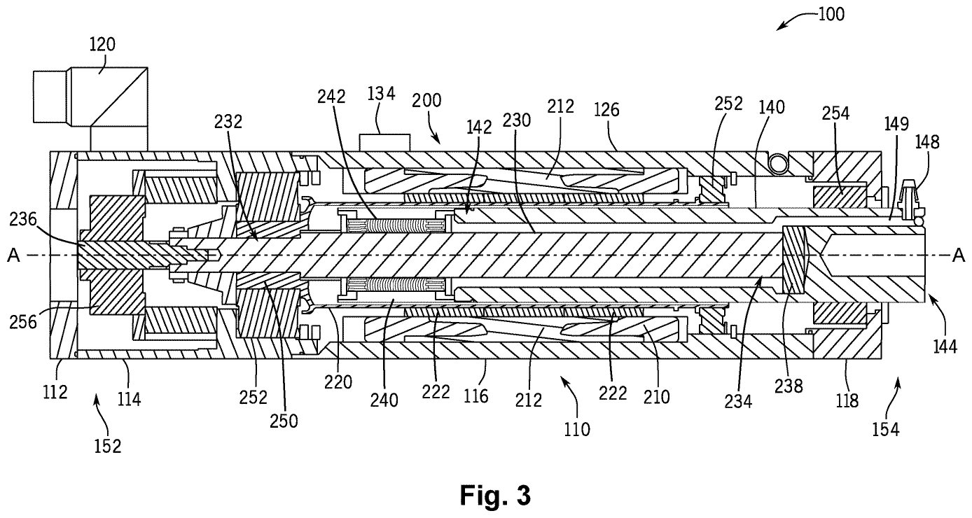

Output rod 140 extends from a proximal (inner) end 142 disposed inside housing 110 (see FIG. 3), to a distal (outer) end 144 disposed outside housing 110. For example, the distal end 144 of output rod 140 can be disposed proximate the head assembly 118 along longitudinal axis A, as shown in FIG. 1.

The distal end 144 of output rod 140 can also be provided with a machine fitting or other coupling adapted for connecting to a welding gun or machine tool fixture, or to a workpiece or end effector. A “flat” or similar anti-rotation feature 146 can be disposed along one or both sides of output rod 140 in order to maintain rotational orientation, and a “grease zerk” or lubrication fitting 148 can be provided to lubricate internal components of the actuator 100.

### Cooling Configurations

In FIG. 1, the linear actuator system 100 is shown as including a cooling loop 132 at least partially embedded, potted or seated with a thermally conductive material 123, within a channel or recessed feature 125 defined in the actuator housing 110. The thermally conductive material 123 can be disposed about (or at least partially about) the cooling loop 132, in order to conduct heat from the top side 126 of the actuator housing 110. The cooling loop 132 can include a hollow interior conduit or tube through which cooling fluid is routed, with fluid couplings 134 to couple cooling loop 132 with a fluid source for circulating the cooling fluid. Depending on application, the fluid couplings 134 can include inlet and outlet couplings, valves or quick-disconnect features adapted for removable attachment of the cooling loop 132 to a conduit, hose or other fluid flow component configured to cycle fluid through the cooling loop 132.

In FIG. 1, the cooling loop 132 is provided in or on the top side 126 of actuator housing 110; e.g., at least partially embedded, potted or seated in recess 125. Thus, the cooling system 130 conducts heat from the first side 126 of housing 110, while the opposite side 128, on the bottom of actuator housing 110 (see, e.g., FIGS. 2A, 2B). In other applications single or multiple cooling loops 132 can be provided with corresponding recessed features 125 formed in or on any of the respective sides 124, 126, 128 of the actuator housing 110, or two or more of the sides 124, 126, 128, or on all of the sides 124, 126, 128.

In other examples, the sides 124, 126, or 128 of the actuator housing 110 can be adapted to receive a modular cooling system 130, such as a modular cooling jacket or cooling module that attaches to any one or more sides 124, 126, 128 of the actuator housing 110, and configured with either active or passive (e.g., radiative or convective) components. For example, a modular cooling system 130 can be provided in the form of a heat sink apparatus, which is configured to dissipate heat from one or more selected sides 124, 126, 138 of the housing 110 of linear actuator system 100 with or without the need for external cooling fluid flow through a conduit or cooling loop 132. In heat sink embodiments, fins or similar passive radiating or convective cooling structures may be provided on the cooling assembly 130; e.g., on the external surface of a thermal mass or block in contact with one or more selected sides 124, 126, 128 of the housing 110, and in thermal contact with the surrounding air or other medium.

Depending on application, fluid flow may also be provided to increase or improve heat transport from the inner surfaces of assembly 130 adjacent the housing 110 of linear actuator system 100 to the outer radiating and convective surfaces exposed to the surrounding medium. The flow may be internal or external, with or without fluid inlet and outlet connections 134. One or more modular cooling systems 130 can thus be provided on one, two or more selected sides 124, 126, 128 of the actuator housing 110, each with any combination of internal fluid flow, external cooling flow, cooling fins and/or other radiative or convective features, in active or passive form.

FIG. 2A is a rear isometric view of an actuator (or actuator system) 100. FIG. 2B is a rear elevation view of the actuator 100.

As shown in FIGS. 2A and 2B, the rear cover 112 and rear section 114 of housing 110 define a proximal region or back end 152 of actuator 100, with the front cover (head assembly) 118 at the front end (distal region) 154, opposite the back end 152. The sides 124 of housing 110 can be oriented in a generally parallel configuration, extending vertically between the generally parallel top 126 and bottom 128, extending horizontally between sides 124.

While the designations of “top,” “bottom,” “side,” “horizontal” and “vertical” cab be used for convenience, they are merely representative, and can be interchanged without loss of generality depending on the orientation of actuator 100 and housing 110. The configuration of housing 110 and its individual sections or components 112, 114, 116, 118 may also vary, along with size, shape, position and detailed configuration of the external connectors 120 and mechanical couplings 122.

FIG. 3 is a section view of an actuator (actuator system) 100, taken along line B-B of FIG. 2B. A motor assembly 200 is located inside the main or central section 116 of actuator housing 110.

In this particular configuration, motor assembly 200 includes a stator (or stator assembly) 210 with stator windings (or motor windings) 212, and a hollow-core rotor 220 with magnets 222. An externally threaded screw shaft (or roller screw) 230 extends coaxially inside rotor 220 along longitudinal axis A, engaged with a planetary roller nut assembly (or roller nut) 240, coaxially disposed about screw shaft 230 and at least partially within rotor 220. Roller nut assembly 240 has an integrated gear ring design that is configured to improve manufacturing and operational efficiency, as described herein.

As shown in FIG. 3, the rear cover 112 and rear housing 114 are connected to the central housing 116 at the back end 152 of actuator 100; e.g., using one or more mechanical connectors. The head assembly 118 is coupled to the central housing 116 at the front end 154 of actuator 100, opposite the back end 152. Again, while designations such as “front” and “back” can be used for convenience they are merely representative, and can be interchanged without loss of generality depending on the orientation of actuator 100 and housing 110.

Magnets 222 are disposed on an outer radius of rotor 220, radially inward of the stator windings 212, across an air gap. For example, magnets 222 can include or comprise surface-mounted permanent (SPM) magnets, or other permanent magnetic components, or magnets 222 can include electromagnetic elements.

Stator 210 is fixed relative to the actuator housing 110, for example along the inside surface of central housing section 116. Stator windings 212 are positioned radially outward of rotor 220 and magnets 222, across the air gap. The windings 212 are configured to generate magnetic flux in response to a drive current. The flux extends across the air gap to interact with rotor magnets 222, driving rotor 220 into rotation about axis A.

Rotor 220 may have a generally hollow cylindrical configuration as shown, and can be rotationally coupled to an externally threaded screw shaft 230, extending coaxially inside rotor 220 along longitudinal axis A. The roller nut assembly 240 can be coaxially engaged about screw shaft 230, and coupled to the proximal end 142 of the output rod 140 (or to a thrust tube, or similar load transfer component).

As shown in FIG. 3, the roller nut assembly 240 can be positioned at least partially or fully inside rotor 220; that is, radially inward of rotor 220 and extending coaxially along axis A. In this particular configuration, roller nut assembly 240 includes a set of multiple threaded planetary rollers 242, which are configured to engage roller nut assembly 240 with the externally threaded portion of screw shaft 230. The output rod 140 can be rotationally locked via a flat or other keying mechanism, as described above, utilizing roller nut assembly 240 to convert rotational motion of the rotor 220 and screw shaft 230 into linear thrust, driving output rod 140 into along axis A.

In contrast to traditional designs, roller nut assembly 240 can be provided with an integrated gear ring configuration, as described herein. Screw shaft 230 extends axially through roller nut assembly 240 from a proximal end 232 disposed toward the back end 152 of actuator 100 and housing 110 to a distal end 234 disposed toward the front end 154. The proximal end 232 of screw shaft 230 can be coupled to rotor 220 via a hub 250, which is supported on one or more thrust bearings or rotational bearings 252.

As shown in FIG. 3, for example, the proximal (back) end 232 of screw shaft 230 is rotationally coupled to rotor 220 via a hub 250 supported on one or more thrust bearings 252, so that rotation of the rotor 220 causes a corresponding rotation of screw shaft 230 about longitudinal axis A. The rotor 220 and hub 250 can formed as separate parts, or provided as a single, integrated rotor component. Additional bearings 252 can be provided to support rotor 220 toward the front end 154 of the housing, and a guide bushing 254 can be provided to support the distal end 144 of output rod 140. Bushing 254 can also be configured to prevent rotation of the output rod 140; e.g., by conforming to one or more flats or other anti-rotation features 146 defined at the distal end 144 of output rod 140 as shown in FIG. 1, or via a keyed arrangement.

The proximal end 232 of screw shaft 230 extends through hub 250 to an adapter or coupling 236, which is configured to couple screw shaft 230 to a rotary encoder 256 or other position sensing device. The distal (front) end 234 of screw shaft 230 is disposed within the hollow output rod (or thrust tube) 140; e.g., proximate the head assembly 118. A stop 238 can be provided on the distal end 234 of screw shaft 230, for example a stop 238 formed of a resilient material configured to absorb energy if output rod 140 is retracted far enough for any interior structures to approach the adjacent distal end 234 of screw shaft 230.

In operation of actuator system 100, drive currents are induced in the windings 212 of a stator assembly 210 attached to the interior of the actuator housing 110; e.g., with windings 212 extending longitudinally along the central housing section 116. Rotor magnets 222 are disposed adjacent the stator windings 212 across an air gap, and configured to interact with magnetic flux generated by the windings 212 to drive rotor 220 into rotational motion about longitudinal axis A.

Rotor 220 is rotationally coupled to screw shaft 230 (e.g., at hub 250), so that rotor 220 and shaft co-rotate about axis A. Roller nut assembly 240 is attached to output rod 140 at proximal end 142, and engages the externally threaded screw shaft 230 via planetary rollers 242, converting rotational motion of rotor 220 and screw shaft 230, as defined about longitudinal axis A, into linear (axial) motion of output rod 140, as defined along axis A.

The distal end 144 of output rod 140 is positioned outside the actuator housing 110 along axis A, in response to rotation of the rotor 220 and screw shaft 230. For example, the drive currents can be selected to drive rotor 220 into rotation in either a clockwise or anticlockwise direction about longitudinal axis A, and thus to drive output rod 140 in either a proximal or distal direction for desired positioning of the distal end 144 along axis A. The distal end 144 of output rod 140 can be configured to position a weld electrode, machine tool fixture, or workpiece for use in an automated manufacturing, assembly or packaging process, to operate a spray tool for automated coating, or for use in a transportation system (e.g., for braking or steering), or other automated process or system.

The relationship between rotational motion of the rotor 220 and reciprocal motion of the output rod 140 is arbitrary, can be defined in either a clockwise or anticlockwise sense, depending on nut and thread configuration. A stationary screw shaft 230 with a rotating nut 240 can also be utilized, or an inverted roller screw design with the functions of the screw shaft 230 and nut 240 substantially reversed.

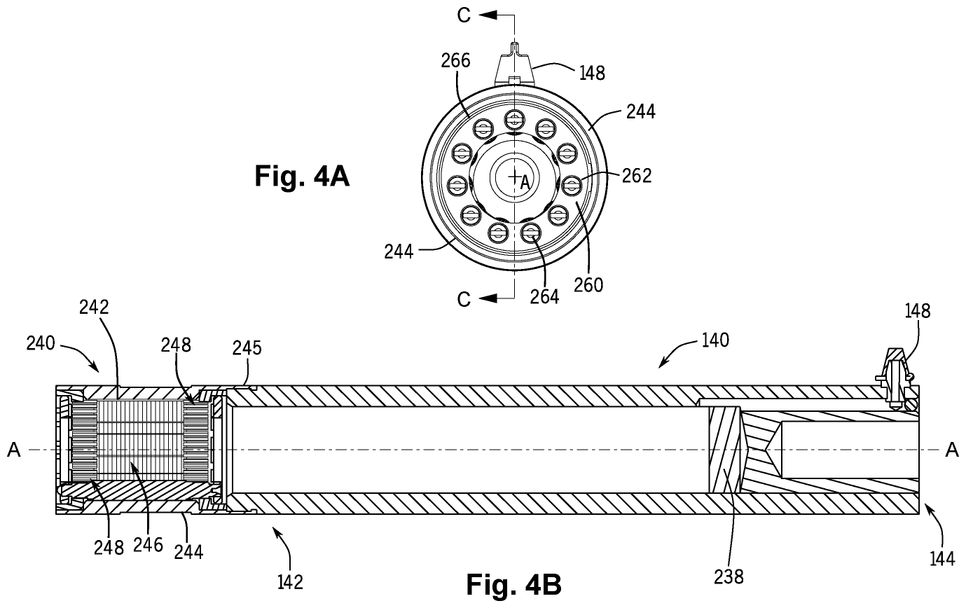

FIG. 4A is an end view of an output rod and roller nut assembly for an actuator system, for example an output rod 140 and roller nut assembly (or roller nut) 240 as described herein. FIG. 4B is a section view of the output rod 140 and roller nut assembly 240, taken along line C-C of FIG. 4A.

As shown in FIGS. 4A and 4B, roller nut assembly 240 includes a set of planetary rollers 242 disposed within a carrier (or nut housing) 244, and circumferentially arranged about longitudinal axis A. The carrier 244 is coupled to the proximal end 142 of output rod 140; e.g., using a complementary threaded coupling, press fit, interference fit or friction fitting 245, or by welding or other mechanical coupling.

As shown in FIG. 4B, planetary rollers 242 extend longitudinally inside carrier 244. Each roller 242 has external threads 246 defined in a central portion, and configured to engage with the externally threaded section of the screw shaft. Roller gear teeth 248 are provided at the opposing ends of each planetary roller 242, and configured to engage with complementary gear ring elements formed on the inside surfaces of the carrier 244, as further described herein.

### Integrated Gear Ring Planetary Roller Nut Assemblies

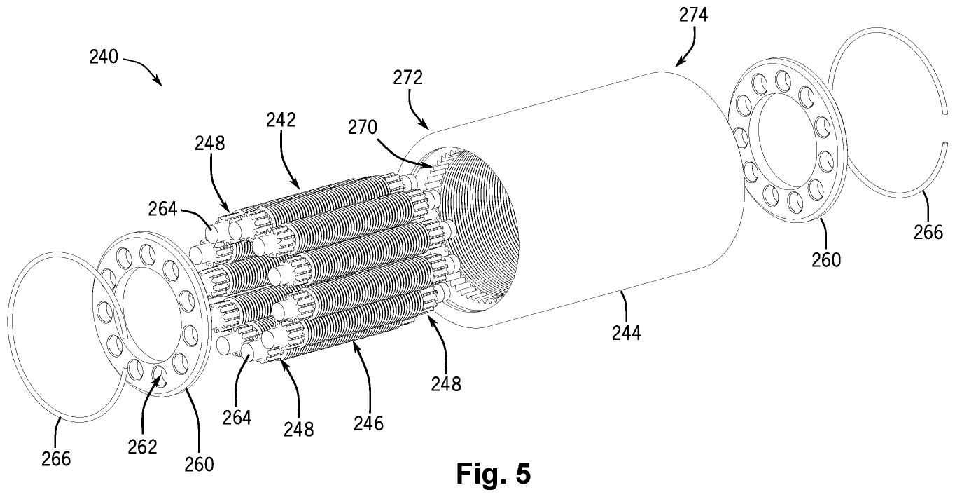

FIG. 5 is an exploded view of a planetary roller nut assembly (or roller nut) 240, illustrating the integrated gear ring configuration. As shown in FIG. 5, roller nut assembly 240 includes a plurality of elongated planetary rollers 242 that can be disposed inside a generally cylindrical carrier or housing 244, and arranged along the inner surface thereof.

As shown in FIG. 5, roller nut assembly 240 is provided with a matched set of multiple threaded planetary rollers 242. Individual rollers 242 extend longitudinally between roller gear teeth 248 at either end, through a middle section with external threads 246. The roller threads 246 can be formed with generally triangular cross section, extending between the roller gear teeth 248 at either end.

Spacer rings 260 are configured to support planetary rollers 242 within carrier 244. For example, each spacer ring 260 can be provided with a set of circumferentially arranged openings or apertures 262, which are configured to engage a spindle end (or end section) 264 defined on each end of the corresponding rollers 242.

Snap rings, retaining rings or similar (e.g., substantially circular) retainers 266 can be configured to secure the spacer rings 260 inside the carrier 244, so that the spacer rings 260 are axially retained against a stop or ledge structure defined at or adjacent the gear rings 270 at each end 272, 274 of the carrier 244. When assembled, the planetary rollers 242 are thus arranged about the inner circumference of carrier 244, supported between the spacer rings 260. The roller threads 246 engage an externally threaded screw shaft, extending along the central axis A, and the roller gear teeth 248 engage the gear rings 270 at each opposing end 272, 274 of carrier 244, axially adjacent (and inside of) the spacer rings 260.

In contrast to traditional planetary roller nut designs using separate and distinct gear ring components that are drilled and pinned or otherwise mechanically attached to the carrier 244, the planetary roller nut of FIG. 5 utilizes an integrated gear ring configuration. In this configuration, carrier 244 can be formed as a unitary, generally cylindrical structure with gear rings 270 formed on or into the inner circumference of carrier 244 at each opposing (e.g., first and second) end 272, 274, without the need for additional mechanical couplings or attachments.

For example, suitable gear rings 270 can be machined into the inner circumference of carrier 244 at each end 272, 274, or gear rings 270 can be formed together with carrier 244 by molding, casting, volume printing, additive manufacturing, volume additive manufacturing, or a similar process. The material of carrier 244 can thus be substantially uniform and homogeneous between the first and second ends 272, 274, extending from the outer diameter to the inner diameter of carrier 244 and including gear rings 270, absent any threaded couplings, mechanical attachments, welds, or other connecting elements.

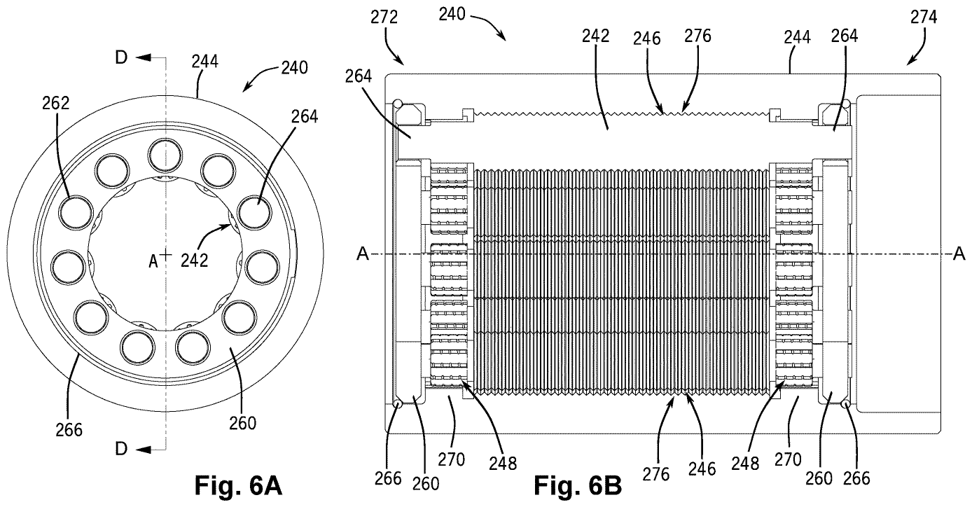

FIG. 6A is an end view of an assembled roller nut assembly 240. FIG. 6B is a section view of roller nut assembly 240, taken along line D-D of FIG. 6A.

As shown in FIGS. 6A and 6B, planetary rollers 242 are disposed about the inner circumference of carrier 244. Rollers 242 extend longitudinally within carrier 244, supported at each end by spacer rings 260; e.g., with spindle ends 264 engaged in apertures 262 as described above. Spacer rings 260 are axially engaged against or adjacent the gear rings 270 at each end 272, 274 of carrier 244, and secured with snap rings or retainers 266.

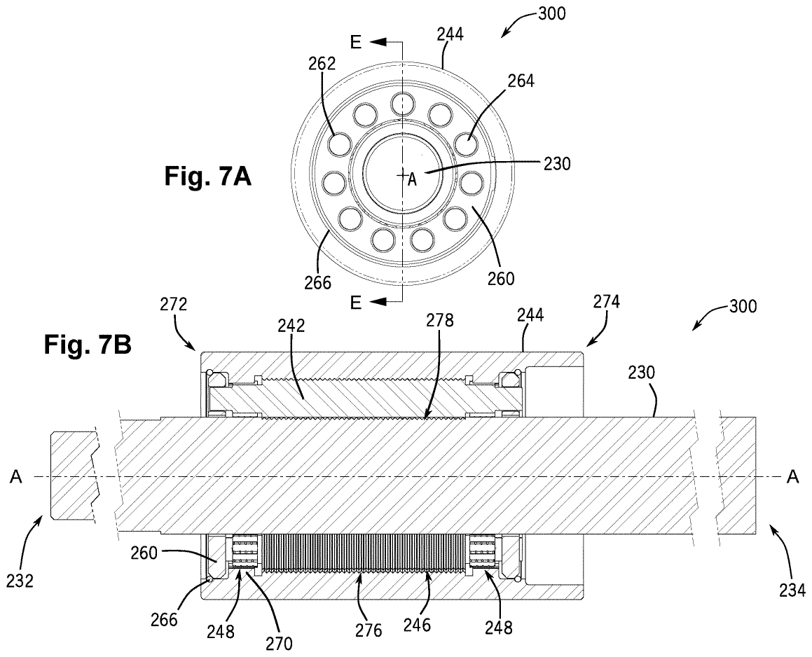

Gear rings 270 engage the complementary roller gear teeth 248 defined on each end of the planetary rollers 242, between the roller threads 246 in the middle section of each roller 242, and the spindle ends 264. The roller threads 246 simultaneously engage the inner carrier thread 276 and the complementary, externally threaded section of the screw shaft (see FIG. 7B), causing rollers 242 to rotate inside carrier 244. In the integrated gear ring configuration of FIGS. 6A and 6B, roller nut assembly 240 can also provide higher force transmission capability and improved service life.

### Integrated Gear Ring Planetary Roller Screw Assemblies

FIG. 7A is an end view of a planetary roller screw assembly 300 for an actuator system, with integrated gear ring design. FIG. 7B is a section view of the roller screw assembly 300, taken along line E-E of FIG. 7A.

As shown in FIGS. 7A and 7B, planetary rollers 242 are disposed along the inner periphery of carrier 244, arranged circumferentially about longitudinal axis A. Spacer rings 260 are disposed within carrier 244 at each opposing end 272, 274, and axially secured with retainers 266 to support rollers 242 by engaging the spindle ends 264 within the corresponding apertures 262.

The external threads 246 of the planetary rollers 242 are simultaneously engaged between the internal carrier thread 276, defining the internally threaded portion of the carrier 244, and the external screw thread 278, defining the externally threaded section of the screw shaft. Upon rotation of the screw shaft 230, the rollers 242 rotate within the carrier 244, converting the rotational motion of screw shaft 230 (that is, about longitudinal axis A) into axial motion of the roller nut assembly 240 (along axis A).

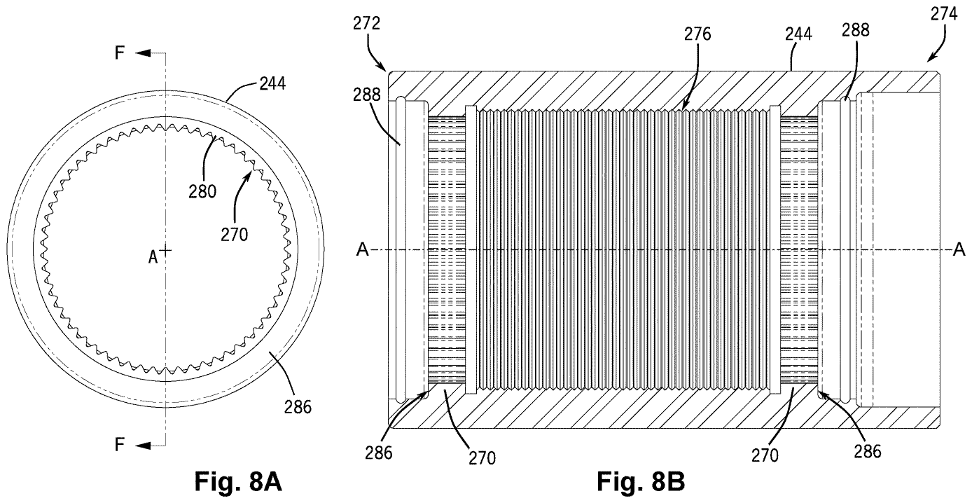

FIG. 8A is an end view of a planetary roller nut carrier 244, with integrated gear ring 270. FIG. 8B is a section view of the carrier 244, taken along line F-F of FIG. 8A.

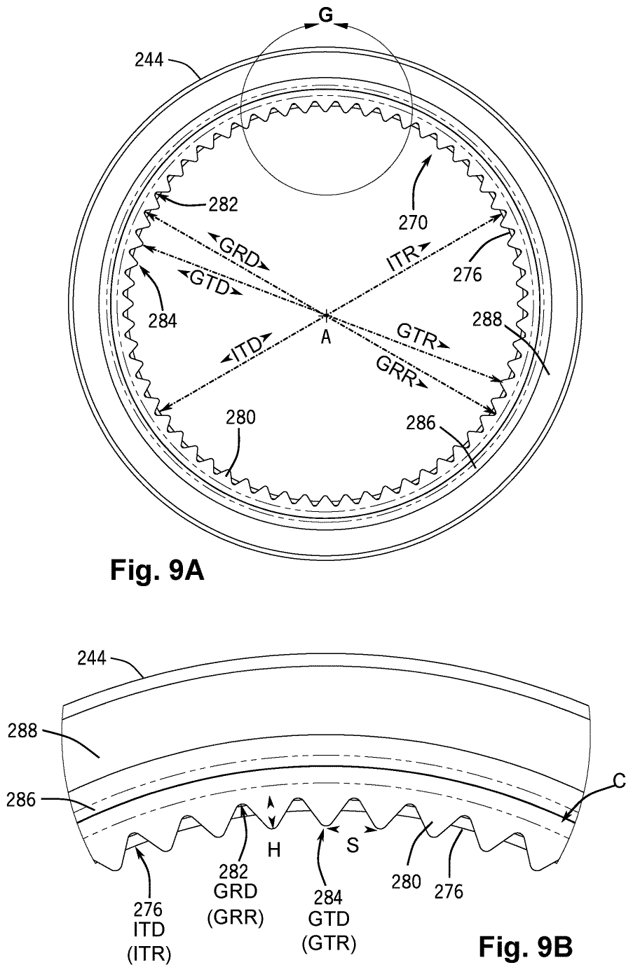

As shown in FIGS. 8A and 8B, gear rings 270 are defined by sets of gear ring teeth 280 disposed about the inner circumference of carrier 244, each extending from a root 282 to a cusp or crest 284 (e.g., as shown in FIG. 9B). A ledge or seat 286 can be defined adjacent each gear ring 270; e.g., for engagement with a spacer ring 260 at each end 272, 274 of the carrier 244. A groove or seat 288 can also be provided for engagement with a snap ring or retainer 266; e.g., securing spacer rings 260 inside carrier 244. The position and geometry of seat/ledge 286 and seat/groove 288 may also vary; e.g., as further illustrated in FIGS. 7A and 7B, or otherwise depending on application geometry.

FIG. 9A is an end view of carrier 244, illustrating the integrated gear ring 270. FIG. 9B is a detail view of carrier 244, illustrating the gear ring teeth 280.

Gear ring teeth 280 extend radially inward from a root 282 adjacent the inner circumferent C, defining the radially outermost point of gear ring tooth 280, to crest 284, defining the radially innermost point of each gear ring tooth 280. The tooth height His defined between adjacent roots 282 and crests 282, and the tool width or spacing S is defined between adjacent roots 282 or crests 284.

As shown in FIGS. 9A and 9B, gear ring teeth 280 can be machined directly into or formed directly onto the inner surface of carrier 244 and arranged circumferentially about axis A, for example along an inner circumference C defined adjacent the spacer ring seat 286 (see also, e.g., FIGS. 7A, 7B). This configuration distinguishes from traditional planetary roller screw assemblies, where the gear rings are formed as separate components that must be drilled and pinned for attachment to the carrier 244, or otherwise mechanically fastened to the nut. Instead, gear ring teeth 280 can be machined directly into or formed directly onto the inner surface of the carrier body, along inner circumference C.

### Gear Root, Tooth and Carrier Inner Thread Geometry

As further illustrate in FIGS. 9A and 9B, The roots 282 of gear ring teeth 280 define the gear root radius (GRR), measured from central axis A to the root 282 of each gear ring tooth 280. Similarly, the gear tooth radius (GTR) is measured from the central axis A to the crests 284 of gear ring teeth 280, and the inner thread radius (ITR) is measured from central axis A to the inner radius of the carrier thread 276.

The gear root diameter (GRD) is twice the gear root radius (GRD=2×GRR), measured between the roots 282 of opposing gear ring teeth 280, defined across the central axis A (or at diametrically opposed locations on a circle running through the roots 282 of gear ring teeth 280). Similarly, the gear tooth diameter (GTD) is twice the gear tooth radius (GTD=2×GTR), measured between opposing crests 284 (or at diametrically opposed locations on a circle running through the crests 284), and the inner thread diameter (ITD) is twice the inner thread radius (ITD=2×ITR), measured between opposing locations on inner radius of the carrier thread 276.

Unlike other prior art designs, gear ring 270 and carrier inner thread 276 define a novel gear root diameter to thread minor diameter relationship. As shown in FIGS. 9A and 9B, the gear root diameter (GRD) of the gear ring teeth 280 is at least as great as or greater than the inner thread diameter (ITD) of the inner carrier thread 276 (that is, GRD≥ITD). Thus, the roots 282 of gear ring teeth 280 can be disposed radially outward of the inner carrier thread 276, with gear root radius greater than the inner thread radius (GRR>ITR), or alternatively at the same radial distance as the inner thread (GRR=ITR).

Conversely, the gear tooth diameter (GTD) of the gear ring teeth 280 may be less than or equal to the inner thread diameter (ITD) of the inner carrier thread 276 (that is, GTD≤ITD). Thus, the crests 284 of the gear ring teeth 280 may be disposed radially inward of the carrier thread 276, with gear tooth radius less than or equal to the inner thread radius (GTR<ITR), or alternatively at the radial distance as the inner thread (GTR=ITR).

While these configurations pose substantial challenges for broaching and other traditional machining techniques, they allow for increased gear ring tooth height H and width or spacing S, improving gear-to-gear alignment for better operational precision and efficiency. The gear ring teeth 280 may also be formed by alternative techniques, providing for increased mass as defined by the individual gear ring teeth 280, with enhanced thermal performance.

For example, the inner carrier thread 276 can be formed with a first manufacturing technique, adapted to provide the inner carrier thread 276 at a defined inner thread diameter (ITD) or inner thread radius (ITR). The gear ring teeth 280 can be formed with a second manufacturing technique, adapted for the gear root diameter (GRD) or radius (GRR) to be at least as great as or greater than the corresponding inner thread diameter (GRD>ITD) or radius (GRR≥ITR) of the inner carrier thread 276; e.g., with the roots 282 of the gear ring teeth 280 radially aligned with or disposed radially outward of the inner carrier thread 276, and with the gear tooth diameter (GTD) or radius (GTR) less than or equal to the corresponding inner thread diameter (GTD≤ITD) or radius (GTR≤ITR) of the inner carrier thread 276; e.g., with the crests 284 of the gear ring teeth 280 radially aligned with or disposed radially inward of the carrier thread 276.

Suitable roller nut assemblies 240 and roller screw assemblies 300 with a roller nut 240 and screw shaft 230 can be formed using an integrated carrier 244 and gear ring 270 as described herein, for example using manufacturing techniques according to one or more of the planetary roller screw designs described in “Planetary Roller Screws” by Tolomatic, Inc (Lit. No. 9900-4055_06; Jan. 17, 2025), which is incorporated by reference herein, in the entirety and for all purposes. Suitable first and second manufacturing techniques are also described in the additional Tolomatic, Inc. references “Selecting the Optimal Screw Technology” (Lit. No. 9900-4644_05; Aug. 31, 2021), “How roller-screw and ball-screw actuators compare in high-force applications,” (Lit. No. 9900-4060_01; May 19, 2020), and in “Roller screw technology for electric actuators” by Ryan Klemetson (Aug. 25, 2000), available at https://www.tolomatic.com/blog/roller-screw-technology-for-electric-actuators, and in the Klingelberg whitepaper by Müller et al., “Good Things Need Some Time” (Jan. 23, 2017), each of which is incorporated by reference herein, in the entirety and for all purposes. The first and second manufacturing techniques can be the same or different, depending on example, and may be performed in any order or combination; e.g., with the carrier 244 disposed on the same or different machine fixtures for each step in the process.

### Roller Nut, Roller Screw Assembly and Actuator System Examples

In various examples, a suitable roller nut assembly 240 can include a carrier 244 as described herein, disposed about an axis A. The carrier 244 can have an inner carrier thread 276 defined on a radially inner surface of the carrier 244, and a set of gear ring teeth 280 defined on each opposing end 272, 274 of the carrier 244, adjacent the inner carrier thread 276 along the inner surface. A plurality of (e.g. planetary) rollers 242 can be disposed inside the carrier 244 and circumferentially arranged about the axis A; e.g., with each roller 242 having an external roller thread 246 defined on a radially outer surface of the roller 242 and sets of roller gear teeth 248 defined at opposing ends of the roller 242, adjacent the roller thread 246 defined along the outer surface of the roller 242.

The roller threads 246 can be configured to engage the carrier thread 276 along the inner surface of the carrier 244, with the roller gear teeth 248 simultaneously engaging the gear ring teeth 280 on the opposing ends 272, 274 of the carrier 244. The gear ring teeth 280 can be defined directly on or along the inner surface of the carrier 244, formed of a same continuous material with the carrier 244 and the carrier thread 276, without any pins, screws, threaded coupling, interference fit, or other separate or distinct mechanical coupling defined between the carrier thread 276 and gear ring teeth 280.

The gear ring teeth 280 each extend from a root 282 to a cusp or crest 284, with the roots 282 of the gear ring teeth 280 defining a gear root diameter (GRD) measured across the axis A and the carrier thread 276 defining an inner thread diameter (ITD) measured across the axis A. The gear root diameter (GRD) can be greater than the inner thread diameter (ITD). The roots 282 of the gear ring teeth 280 can be defined radially outward of the carrier thread 276, with respect to the central axis A.

Depending on application, the cusps or crests 284 of the gear ring teeth 280 can define a gear tooth diameter (GTD) measured across the axis A, where the gear tooth diameter (GTD) is less than or equal to the inner thread diameter (ITD). The gear tooth diameter (GTD) can be less than the inner thread diameter (ITD), so that the cusps or crests 284 of the gear ring teeth 280 are defined radially inward of the carrier thread 276, with respect to the axis A.

In some examples, the roots 282 of the gear ring teeth 280 define a gear root radius (GRR) measured to the axis A, for example where the carrier thread 276 defines an inner thread radius (ITR) measured to the axis A, and where the gear root radius (GTR) is greater than the inner thread radius (ITR). The cusps or crests 284 of the gear ring teeth 280 can define a gear tooth radius (GTR) measured with respect to the axis A, where the gear tooth radius (GTR) is less than or equal to the inner thread radius (ITR). The gear tooth radius (GTR) can be less than the inner thread radius (ITR), so that the crests 284 of the gear ring teeth 280 are defined radially inward of the carrier thread 276, with respect to the axis A.

A roller screw assembly 300 can be formed with a screw shaft 230 and roller nut 240 with a plurality of planetary rollers 242, as described herein. For example, the screw shaft 230 can be disposed along an axis A, with an external screw thread 278 defined on a radially outer surface of the screw shaft 230. The roller threads 246 defined on the outer surfaces of the rollers 242 can be configured to engage the screw thread 278 along the outer surface of the screw shaft 230.

Depending on example, the carrier 244 and/or roller nut 240 can be configured for translation along axis A, in response to relative rotation of the screw shaft 230 about the axis A. The screw shaft 230 can also be configured for translation along the axis A, in response relative rotation of the carrier 244 and/or roller nut 240 about the axis A. An actuator system 100 can thus be provided with a screw assembly 300 where the actuator system 100 is configured to convert rotational motion of a rotor 220 about axis A into linear motion of either the screw shaft 230 or the carrier 244 and/or roller nut assembly 240 or along the axis A.

A roller screw assembly 300 can be provided as described herein, for example with a roller nut assembly 240 including a carrier 244 disposed about an axis A. The carrier 244 can be provided with an inner carrier thread 276 defined on a radially inner surface of the carrier 244, and a set of gear ring teeth 280 defined on each opposing end 272, 274, adjacent the carrier thread 275 along the inner surface of the carrier 244.

A screw shaft 230 cam be disposed along the axis A, with an external screw thread 278 defined on a radially outer surface of the screw shaft 230. A plurality of (e.g., planetary) rollers 242 can be disposed inside the carrier 244, and circumferentially arranged about the axis A. Each roller 242 can have an external roller thread 246 defined on a radially outer surface of the roller 242, and sets of roller gear teeth 248 defined at opposing ends of the roller 242, adjacent the roller thread 246 defined along the outer surface of the roller 242.

The roller threads 246 can be configured to engage the carrier thread 276 along the inner surface of the carrier 244, and the screw thread 278 along the outer surface of the screw shaft 230. The roller gear teeth 248 and gear ring teeth 280 can be engaged along the opposing ends 272, 274 of the carrier 244.

The gear ring teeth 280 can be defined directly on or along the inner surface of the carrier 244, and formed of a same continuous material with the carrier 244 and the carrier thread 276. Thus, there is no need for pins, screws, threaded or interference fittings, or other separate or distinct mechanical coupling between the carrier thread 276 and the gear teeth 280.

The gear ring teeth 280 each extend from a root 282 defining a great root radius (GRR) with respect to the axis A, and a cusp or crest 284 defining a gear tooth radius (GTR) with respect to the axis A. For example, the gear root radius (GRR) can be greater than an inner thread radius (ITR) of the carrier thread 276, and the gear tooth radius (GTR) can be less than or equal to the inner thread radius (ITR) of the carrier thread 276. The gear tooth radius (GTR) can be less than the inner thread radius (ITR), so that the roots 282 of the gear ring teeth 280 are defined radially outward of the carrier thread 276, and the cusps or crests 284 of the gear ring teeth 280 are defined radially inward of the carrier thread 276.

The carrier 244 and/or roller nut assembly 240 can be configured for translation along the axis A in response to relative rotation of the screw shaft 230 about the axis A. The screw shaft 230 can be configured for translation along axis A in response to relative rotation of the carrier 244 and/or roller nut assembly 240 about the axis A.

An actuator system 100 can be provided with a roller screw assembly 300 as described herein. For example, a housing 110 can be disposed about the roller screw assembly 300. A motor assembly 200 can be provided with a stator 210 fixed relative to the housing 110, and a rotor 220 having a set of magnets 222 can be disposed adjacent the stator 210; e.g., with the rotor 220 coaxially disposed about the screw shaft 230, extending along the axis A.

An output rod 140 can be coupled to the carrier 244 and/or roller nut assembly 240, for example with the rotor 220 configured for rotation about the axis A in response to flux generated by the stator 210. The roller screw assembly 300 can be configured to move or translate the output rod 140 along the axis A, in response to the rotation of the rotor 220 about axis A. The rotor 220 can be rotationally coupled to the screw shaft 230, so that the carrier 244 and/or roller but assembly 240 and the output rod 140 translate along the axis A, in response to the rotation of the rotor 220.

### Processes and Methods of Manufacture

In process and method applications, a carrier 244 can be provided with an inner carrier thread 276 defined on a radially inner surface of the carrier 244. A set of gear ring teeth 280 can be formed on each opposing end 272, 274 of the carrier 244, adjacent the carrier thread 276 along the inner surface of the carrier 244.

The gear ring teeth 280 each extend from a root 282 to a cusp or crest 284 defined on or along the inner surface of the carrier 244, formed of a same continuous material with the carrier 244 and carrier thread 276. The gear ring teeth 280 can thus be formed on or along the inner surface of the carrier 244 without any pins, screws, threaded couplings, interference fittings, or other separate or distinct mechanical coupling between the carrier thread 276 and gear ring teeth 280.

The roots 282 of the gear ring teeth 280 can be defined radially outward of the carrier thread 276. The cusps or crests 284 of the gear ring teeth can be defined radially inward of the carrier thread 276.

Forming the inner carrier thread 276 on or along the radially inner surface of the carrier 244 can be performed in a first manufacturing process, and forming the gear ring teeth 280 on or along the radially inner surface of the carrier 244 can be performed in a second manufacturing process. For example, the first manufacturing process can be performed with the carrier on a first machine fixture, and the second manufacturing process can be performed with the carrier on a second machine fixture, different from the first machine fixture. The first manufacturing process and the second manufacturing process can also be performed with the carrier on a same machine fixture, for both processes to be performed in order or at the same time.

A plurality of (e.g., planetary) rollers 242 can be disposed inside the carrier 244; e.g., with each roller 242 having an external roller thread 246 engaging the carrier thread 276 and sets of roller gear teeth 248 engaging the gear ring teeth 280 on the opposing ends of the carrier. An externally threaded screw shaft 230 can be disposed inside the plurality of rollers 242; e.g., where the external roller threads 246 simultaneously engage the carrier thread 276 and an external screw thread 278 on the externally threaded screw shaft 230.

### Robotic Systems

The roller nut and roller screw assemblies and actuator systems described here also have applicability to robotic systems. These application include, but are not limited to, robotic welding systems, anthropomorphic (e.g., humanoid) robotic systems, and other specialized automated manufacturing and general-purpose robotic systems, for example as described in U.S. Pat. No. 10,907,772 B2, U.S. Pat. No. 10,300,609 B2 and U.S. Pat. No. 10,253,855 B2, each of which is incorporated by reference herein, in the entirety and for all purposes.

For example, such a robotic system can include a roller nut assembly 240 as described herein, where the roller nut assembly 240 is operably disposed in a leg, arm, or other limb of the robotic system, or in a joint of the robotic system, or in a torso, neck or head region of the robotic system. A robotic system can also be provided with an actuator system 100 as described herein; e.g., where the actuator system 100 is operably disposed in a leg, arm or other limb of the robotic system, or in a joint of such a robotic system, or in a torso, neck or head region thereof.

A robotic system can also be provided with a roller screw assembly 300 as described herein, for example where the roller screw assembly 300 is operably disposed in a leg, arm, or other limb of the robotic system, or in a joint of such a robotic system, or in a torso, neck or head region thereof. A roller screw assembly 300 as described herein can be operably disposed in a leg, arm, or other limb of a robotic system, or in a joint, torso, neck or head region thereof.

These robotic system can have anthropomorphic or humanoid configurations, or other general-purpose robotic system configuration. These robotic systems can also be adapted for use in a particular automated system or manufacturing process.

The process and method applications described here also include disposing a carrier 242 and/or roller nut assembly 240 with a plurality of (e.g., planetary) rollers 242, or a roller screw assembly 300 with a screw shaft 230 and roller nut 240, in the leg, arm, or other limb of a robotic system, or in a joint, torso, neck or head region thereof. The robotic system can be adapted for general-purpose use, for example in an anthropomorphic or humanoid configuration, or configured for use in a particular automated system or manufacturing process.

This application is described with reference to particular examples and embodiments. Changes can be made and equivalents can be substituted to adapt these teachings to other systems, processes, materials, problems and applications, as understood in the art, without departing from the scope of invention. While the scope of the claims is illustrated by the written description and drawings, it is not limited to the examples and embodiments that are disclosed, and encompasses all of the subject matter defined by the language of the appended claims.

TABLE 1
Drawing references

100 actuator system
110 housing
112 rear cover
114 rear housing
116 central housing
118 head assembly (front cover)
120 external connector
122 mechanical coupling
123 thermal conductor
124 side of housing
125 recess
126 top of housing
128 bottom of housing
130 cooling system
132 cooling loop
134 fluid coupling
140 output rod
142 proximal end of output rod
144 distal end of output rod
146 flat (keyed surface)
148 lubrication fitting
152 back end of housing
154 front end of housing
200 motor assembly
210 stator
212 winding
220 rotor
222 magnets
230 screw shaft
232 proximal end of screw shaft
234 distal end of screw shaft
236 adapter/coupling
238 stop
240 roller nut assembly
242 planetary roller
244 carrier
245 roller nut/output rod fitting
246 roller thread
248 roller gear teeth
250 hub
252 bearing
254 bushing
256 encoder
260 spacer ring
262 aperture
264 spindle end
266 retainer
270 gear ring
272, 274 first, second end of carrier
276 inner carrier thread
278 external screw thread
280 gear ring tooth
282 root of gear ring tooth
284 cusp or crest of gear ring tooth
286 seat/ledge
288 seat/groove
300 roller screw assembly
GRD/GRR gear root diameter/radius
ITD/ITR inner thread diameter/radius
A axis; C Circumference; H height; S spacing

1. A roller nut assembly comprising:
a carrier disposed about an axis, the carrier having an inner carrier thread defined on a radially inner surface of the carrier and a set of gear ring teeth defined on each opposing end, adjacent the carrier thread along the inner surface;
a plurality of rollers disposed inside the carrier and circumferentially arranged about the axis, each roller having an external roller thread defined on a radially outer surface and sets of roller gear teeth defined at opposing ends, adjacent the roller thread along the outer surface;
wherein the roller threads engage the carrier thread along the inner surface of the carrier and the roller gear teeth engage the gear ring teeth on the opposing ends of the carrier;
wherein the gear ring teeth are defined directly on the inner surface of the carrier, formed of a same continuous material with the carrier and carrier thread, absent mechanical coupling therebetween;
wherein the gear ring teeth each extend from a root to a crest, the roots of the gear ring teeth defining a gear root diameter measured across the axis and the carrier thread defining an inner thread diameter measured across the axis; and
wherein the gear root diameter is greater than the inner thread diameter.

2. The roller nut assembly of claim 1, wherein the roots of the gear ring teeth are defined radially outward of the carrier thread, with respect to the central axis.

3. The roller nut assembly of claim 2, wherein the crests of the gear ring teeth define a gear tooth diameter measured across the axis, wherein the gear tooth diameter is less than or equal to the inner thread diameter.

4. The roller nut assembly of claim 3, wherein the gear tooth diameter is less than the inner thread diameter, such that the crests of the gear ring teeth are defined radially inward of the carrier thread, with respect to the axis.

5. The roller nut assembly of claim 1, wherein the roots of the gear ring teeth define a gear root radius measured to the axis, wherein the carrier thread defines an inner thread radius measured to the axis, and wherein the gear root radius is greater than the inner thread radius.

6. The roller nut assembly of claim 5, wherein the crests of the gear ring teeth define a gear tooth radius measured to the axis, wherein the gear tooth radius is less than or equal to the inner thread radius.

7. The roller nut assembly of claim 6, wherein the gear tooth radius is less than the inner thread radius, such that the crests of the gear ring teeth are defined radially inward of the carrier thread, with respect to the axis.

8. A roller screw assembly comprising the roller nut assembly of claim 1, and further comprising:
a screw shaft disposed along the axis, the screw shaft having an external screw thread defined on a radially outer surface thereof;
wherein the roller threads on the outer surfaces of the rollers engage the screw thread along the outer surface of the screw shaft.

9. The roller screw assembly of claim 8, wherein:
the carrier is configured for translation along the axis in response to relative rotation of the screw shaft about the axis; or
the screw shaft is configured for translation along the axis in response to relative rotation of the carrier about the axis.

10. An actuator system comprising the roller screw assembly of claim 9, wherein the actuator system is configured to convert rotational motion of a rotor about an axis into linear motion of the roller nut assembly or a screw shaft along the axis.

11. The actuator system of claim 10, wherein the actuator system is operably disposed in a leg, arm or other limb of a robotic system, in a joint of a robotic system, or in a torso, neck or head region of a robotic system, and/or wherein said robotic system has an anthropomorphic or humanoid configuration.

12. A roller screw assembly, comprising:
a carrier disposed about an axis, the carrier having an inner carrier thread defined on a radially inner surface thereof and a set of gear ring teeth defined on each opposing end, adjacent the carrier thread along the inner surface;
a screw shaft disposed along the axis, the screw shaft having an external screw thread defined on a radially outer surface thereof; and
a plurality of rollers disposed inside the carrier and circumferentially arranged about the axis, each roller having an external roller thread defined on a radially outer surface thereof and sets of roller gear teeth defined at opposing ends, adjacent the roller thread along the outer surface of the roller;
wherein the roller threads engage the carrier thread along the inner surface of the carrier and the screw thread along the outer surface of the screw shaft, with the roller gear teeth and gear ring teeth engaged along the opposing ends of the carrier;
wherein the gear ring teeth are defined directly on the inner surface of the carrier, formed of a same continuous material with the carrier and carrier thread, and absent mechanical coupling therebetween;
wherein the gear ring teeth each extend from a root defining a great root radius with respect to the axis and a crest defining a gear tooth radius with respect to the axis; and
wherein the gear root radius is greater than an inner thread radius of the carrier thread and the gear tooth radius is less than or equal to the inner thread radius of the carrier thread.

13. The roller screw assembly of claim 12, wherein the gear tooth radius is less than the inner thread radius, such that the roots of the gear ring teeth are defined radially outward of the carrier thread and the crests of the gear ring teeth are defined radially inward of the carrier thread.

14. The roller screw assembly of claim 12, wherein:
the carrier is configured for translation along the axis in response to relative rotation of the screw shaft about the axis; or
the screw shaft is configured for translation along the axis in response to relative rotation of the roller nut assembly about the axis.

15. A robotic system comprising the roller screw assembly of claim 12, wherein the roller screw assembly is operably disposed in a leg, arm, or other limb of the robotic system, or in a joint of the robotic system, or in a torso, neck or head region of the robotic system, and/or wherein said robotic system has an anthropomorphic or humanoid configuration.

16. An actuator system comprising the roller screw assembly of claim 12, and further comprising:
a housing disposed about the roller screw assembly, extending along the axis;
a motor assembly comprising a stator fixed relative to the housing and a rotor having a set of magnets disposed adjacent the stator, wherein the rotor is coaxially disposed about the screw shaft; and
an output rod coupled to the carrier;
wherein the rotor is configured for rotation about the axis in response to flux generated by the stator;
wherein the roller screw assembly is configured to translate the output rod along the axis in response to the rotation of the rotor; and
wherein the rotor is rotationally coupled to the screw shaft, such that the carrier and output rod translate along the axis in response to the rotation of the rotor.

17. The actuator system of claim 16, wherein the roller screw assembly is operably disposed in a leg, arm, or other limb of a robotic system, or in a joint, torso, neck or head region thereof;
and/or wherein said robotic system has an anthropomorphic or humanoid configuration.

18. A method comprising:
providing a carrier with an inner carrier thread defined on a radially inner surface; and
forming a set of gear ring teeth on each opposing end of the carrier, adjacent the carrier thread along the inner surface;
wherein the gear ring teeth each extend from a root to a crest defined on or along the inner surface of the carrier, formed of a same continuous material with the carrier and carrier thread, absent mechanical coupling therebetween; and
wherein the roots of the gear ring teeth are defined radially outward of the carrier thread and the crests of the gear ring teeth are defined radially inward of the carrier thread.

19. The method of claim 18, further comprising forming the inner carrier thread on or along the radially inner surface of the carrier in a first manufacturing process and forming the gear ring teeth in a second manufacturing process, wherein:
the first manufacturing process is performed with the carrier on a first machine fixture and the second manufacturing process is performed with the carrier on a second machine fixture, different from the first machine fixture; and/or
the first manufacturing process and the second manufacturing process are performed with the carrier on a same machine fixture.

20. The method of claim 18, further comprising:
disposing a plurality of rollers inside the carrier, each roller having an external roller thread engaging the carrier thread and sets of roller gear teeth engaging the gear ring teeth on the opposing ends of the carrier, and
disposing an externally threaded screw shaft inside the plurality of rollers, wherein the external roller threads simultaneously engage the carrier thread and the externally threaded screw shaft; and/or
disposing the carrier, rollers and screw shaft in a leg, arm, or other limb of a robotic system, or in a joint, torso, neck or head region thereof.
